(19) United States
(12) Patent Application Publication
(10) Pub. No.: US 2019/0161103 A1
(43) Pub. Date: May 30, 2019

(54) System, Method, and Computer Program Product for Automatic Inspection of a Train

(71) Applicant: Westinghouse Air Brake Technologies Corporation, Wilmerding, PA (US)

(72) Inventors: Sathya Vagheeswar Venkatasubramanian, Pittsburgh, PA (US); Andrew David Grove, Mars, PA (US)

(21) Appl. No.: 16/193,065

(22) Filed: Nov. 16, 2018

Related U.S. Application Data
(60) Provisional application No. 62/591,488, filed on Nov. 28, 2017.

(51) Int. Cl. B61L 27/00; G05D 1/00; G05D 1/10; B64C 39/02; B61L 25/02; B61L 25/06; B61L 23/04

(52) U.S. Cl. CPC B61L 27/0083; G05D 1/0094; G05D 1/101; B64C 39/024; B64C 2201/12; B61L 25/06; B61L 23/04; B64C 2201/027; B61L 25/02

(57) ABSTRACT

Described are a system, method, and computer program product for automatic inspection of a train including one or more locomotives and/or railcars. The method includes activating, or causing the activation of, at least one scanning drone including at least one sensor configured to obtain primary inspection data of the train. The method also includes communicating at least one set of scanning drone operating instructions configured to cause the at least one scanning drone to obtain the primary inspection data along a travel path associated with the train. The method further includes receiving the primary inspection data from the at least one sensor. In further non-limiting embodiments or aspects, the method includes activating, or causing the activation of, at least one micro drone including at least one sensor configured to obtain secondary inspection data of the train.

### CROSS REFERENCE TO RELATED APPLICATION

This application claims the benefit of U.S. Provisional Patent Application Ser. No. 62/591,488, filed Nov. 28, 2017, and entitled “Systems and Methods for Transforming Rail Transportation,” the entire disclosure of which is incorporated herein by reference.

### BACKGROUND

### Technical Field

The present disclosure relates generally to train inspection and, more particularly, to automatic inspection and review of a train, having one or more locomotives and/or railcars, using remote sensing technology.

### Technical Considerations

Train inspection is often a laborious and intensive process by train personnel. In the case of a train that has become non-operational, such as an unplanned braking event somewhere along the route of train travel, the locomotive operator onboard the train is required to inspect every railcar in the train consist to ensure that it is safe for the train to resume its journey. In some instances, the locomotive operator is also required to identify and/or rectify problems. Some causes of unintended stoppage include, but are not limited to: brake line disconnection, derailment, loss of air pressure in the brake pipe, and/or the like. Often complicating a stoppage is that a train operator often needs to leave the locomotive and proceed to manually inspect each railcar and the connections between each railcar (e.g., mechanical connections, pneumatic conduits, electrical lines, etc.). This process is already time-consuming for daytime and clear-weather inspections, and it is further complicated by dim-light or nighttime conditions, harsh or hazardous weather, dangerous wildlife, extreme temperatures, unsafe surroundings, infrastructure, and/or the like. Furthermore, for a train having 100 or more railcars, which may each measure 60 feet long, manual inspection may require the operator to walk over two miles (totaled down and back) before the train may resume its journey.

There are additional drawbacks to manual inspection. An operator's inspection is often conditioned on what the operator is searching for. If the operator is distracted by the train's surroundings or hampered by environmental conditions, the inspection may be compromised and rendered unreliable. Moreover, abnormal train conditions that are out of the sight-line of the operator may be overlooked entirely, and an operator may not notice conditions/symptoms undetectable by human senses, such as odorless gases, subsonic/supersonic frequencies, sub-surface damage, and/or the like. Additionally, the inspection by the operator is very subjective and is based on the operator's experience and health, and the quality of inspection may vary from operator to operator.

In any of the above circumstances, manual inspection procedures only attempt to identify anomalies and require manual recordation, if at all. In such circumstances, retrospective review of inspection is not possible for any potential forensic review at a later point in time.

Train inspection may also be required in scenarios where there is no suspected abnormalities, but where train inspection is routine for system checkup and/or train cataloging. In the case of cataloging multiple trains each having a number of railcars in a train railyard, manual inspection and individual railcar identification is laborious and potentially dangerous.

Accordingly, there is a need in the art for non-manual inspection of a train. There is a need for automatic/remote-controlled inspection that does not require an operator to personally examine or physically venture along the train. Moreover, there is a need for such non-manual inspection to be able to sense conditions both within and outside the range of human sensing, and for such inspection to quickly and efficiently examine a train for abnormalities so that the train may be repaired if necessary, and resume operation.

### SUMMARY

Generally, provided is an improved system, method, and computer program product for automatic inspection of a train including one or more locomotives and/or railcars. Preferably, provided is an improved system, method, and computer program product for activating, or causing the activation of, a scanning drone including a sensor configured to obtain primary inspection data of the train. Preferably, provided is an improved system, method, and computer program product for communicating a set of scanning drone operating instructions configured to cause the scanning drone to obtain the primary inspection data along a travel path associated with the train. Preferably, provided is an improved system, method, and computer program product for receiving the primary inspection data from the at least one sensor.

In non-limiting embodiments or aspects, provided is a computer-implemented method for automatic inspection of a train including at least one locomotive and at least one railcar. The method includes activating, or causing the activation of, with at least one processor, at least one scanning drone including at least one sensor configured to obtain primary inspection data of the train. The primary inspection data includes at least one of the following: infrared data, visible light spectrum data, temperature data, sample gas data, sound data, ultrasound data, x-ray data, LIDAR data, radar data, or any combination thereof. The method also includes communicating, with at least one processor, at least one set of scanning drone operating instructions configured to cause the at least one scanning drone to obtain the primary inspection data along a travel path associated with the train. The method further includes receiving, with at least one processor, the primary inspection data from the at least one sensor.

In further non-limiting embodiments or aspects, activating, or causing the activation of, the at least one scanning drone may include deploying the at least one scanning drone from a storage compartment positioned on or in the at least one locomotive or the at least one railcar. The at least one scanning drone may be configured to return to the storage compartment after executing the at least one set of scanning drone operating instructions.

In further non-limiting embodiments or aspects, the method may further include activating, or causing the activation of, with at least one processor, at least one micro drone. The at least one micro drone may include at least one sensor configured to obtain secondary inspection data of the train. Secondary inspection data may include at least one of the following: infrared data, visible light spectrum data, temperature data, sample gas data, sound data, ultrasound data, x-ray data, LIDAR data, radar data, or any combination thereof. The method may further include communicating, with at least one processor, at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

In further non-limiting embodiments or aspects, the at least one micro drone may be configured to return to and dock in or on the at least one scanning drone after executing the at least one set of micro drone operating instructions. The at least one micro drone may be configured to affix itself to a part of the train after executing the at least one set of micro drone operating instructions.

In further non-limiting embodiments or aspects, the method may include analyzing, with at least one processor, the primary inspection data to detect at least one abnormal train condition. The method may further include communicating, with at least one processor, at least one notification to at least one operator including a warning of the at least one abnormal train condition.

In further non-limiting embodiments or aspects, the method may include analyzing, with at least one processor, the secondary inspection data to detect at least one abnormal train condition. The method may further include communicating, with at least one processor, at least one notification to at least one operator including a warning of the at least one abnormal train condition.

In further non-limiting embodiments or aspects, the primary inspection data may include at least visible light spectrum data. The method may include communicating, with at least one processor, at least a portion of the visible light spectrum data to a display device of at least one operator for real-time monitoring of the at least one scanning drone. The method may also include automatically generating, with at least one processor, the travel path using at least one of the following: rail track geolocation data, environmental data, train consist data, or any combination thereof. The method further includes storing, with at least one processor, the primary inspection data and/or the secondary inspection data in a non-transitory, computer-readable storage medium located onboard the at least one scanning drone or the train in a configuration to be later analyzed to detect at least one abnormal train condition.

In non-limiting embodiments or aspects, provided is a system for automatic inspection of a train including at least one locomotive and at least one railcar. The system includes at least one scanning drone including at least one sensor configured to obtain primary inspection data of the train. The primary inspection data includes at least one of the following: infrared data, visible light spectrum data, temperature data, sample gas data, sound data, ultrasound data, x-ray data, LIDAR data, radar data, or any combination thereof. The system also includes at least one server computer including at least one processor. The at least one server computer is programmed and/or configured to activate the at least one scanning drone and communicate at least one set of scanning drone operating instructions configured to cause the at least one scanning drone to obtain the primary inspection data along a travel path associated with the train. The at least one server computer is also programmed and/or configured to receive the primary inspection data from the at least one sensor.

In further non-limiting embodiments or aspects, the at least one scanning drone may be configured to, when activated, deploy from a storage compartment positioned on or in the at least one locomotive or the at least one railcar. The at least one scanning drone may be configured to return to the storage compartment after executing the at least one set of scanning drone operating instructions.

In further non-limiting embodiments or aspects, the system may include at least one micro drone including at least one sensor configured to obtain secondary inspection data of the train. The secondary inspection data may include at least one of the following: infrared data, visible light spectrum data, temperature data, sample gas data, sound data, ultrasound data, x-ray data, LIDAR data, radar data, or any combination thereof. The at least one server computer may be further programmed and/or configured to activate the at least one micro drone and communicate at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

In further non-limiting embodiments or aspects, the at least one server computer may be programmed and/or configured to analyze the primary inspection data and/or the secondary inspection data to detect at least one abnormal train condition. The at least one server computer may be programmed and/or configured to communicate at least one notification to at least one operator including a warning of the at least one abnormal train condition.

In further non-limiting embodiments or aspects, the at least one server computer may be further programmed and/or configured to store the primary inspection data and/or the secondary inspection data in a non-transitory, computer-readable storage medium located onboard the at least one scanning drone or the train in a configuration to be later analyzed to detect at least one abnormal train condition.

In non-limiting embodiments or aspects, provided is a computer program product for automatic inspection of a train including at least one locomotive and at least one railcar. The computer program product includes at least one non-transitory computer-readable medium including program instructions that, when executed by at least one processor, cause the at least one processor to activate at least one scanning drone including at least one sensor configured to obtain primary inspection data of the train. The primary inspection data includes at least one of the following: infrared data, visible light spectrum data, temperature data, sample gas data, sound data, ultrasound data, x-ray data, LIDAR data, radar data, or any combination thereof. The program instructions further cause the at least one processor to communicate at least one set of scanning drone operating instructions configured to cause the at least one scanning drone to obtain the primary inspection data along a travel path associated with the train. The program instructions further cause the at least one processor to receive the primary inspection data from the at least one sensor.

In further non-limiting embodiments or aspects, the program instructions may further cause the at least one processor to activate at least one micro drone including at least one sensor configured to obtain secondary inspection data of the train. The secondary inspection data includes at least one of the following: infrared data, visible light spectrum data, temperature data, sample gas data, sound data, ultrasound data, x-ray data, LIDAR data, radar data, or any combination thereof. The program instructions may further cause the at least one processor to communicate at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

In further non-limiting embodiments or aspects, the program instructions may further cause the at least one processor to analyze the primary inspection data and/or the secondary inspection data to detect at least one abnormal train condition. The program instructions may further cause the at least one processor to communicate at least one notification to at least one operator including a warning of the at least one abnormal train condition.

In further non-limiting embodiments or aspects, the program instructions may further cause the at least one processor to store the primary inspection data and/or the secondary inspection data in a non-transitory, computer-readable storage medium located onboard the at least one scanning drone or the train in a configuration to be later analyzed to detect at least one abnormal train condition.

Further non-limiting embodiments or aspects are set forth in the following numbered clauses.

Clause 1: A computer-implemented method for automatic inspection of a train comprising at least one locomotive and at least one railcar, the method comprising: activating, or causing the activation of, with at least one processor, at least one scanning drone comprising at least one sensor configured to obtain primary inspection data of the train comprising at least one of the following: infrared data, visible light spectrum data, temperature data, sample gas data, sound data, ultrasound data, x-ray data, LIDAR data, radar data, or any combination thereof; communicating, with at least one processor, at least one set of scanning drone operating instructions configured to cause the at least one scanning drone to obtain the primary inspection data along a travel path associated with the train; and receiving, with at least one processor, the primary inspection data from the at least one sensor.

Clause 2: The method of clause 1, wherein activating, or causing the activation of, the at least one scanning drone comprises deploying the at least one scanning drone from a storage compartment positioned on or in the at least one locomotive or the at least one railcar.

Clause 3: The method of clause 1 or 2, wherein the at least one scanning drone is configured to return to the storage compartment after executing the at least one set of scanning drone operating instructions.

Clause 4: The method of any of clauses 1-3, further comprising: activating, or causing the activation of, with at least one processor, at least one micro drone comprising at least one sensor configured to obtain secondary inspection data of the train comprising at least one of the following: infrared data, visible light spectrum data, temperature data, sample gas data, sound data, ultrasound data, x-ray data, LIDAR data, radar data, or any combination thereof; and communicating, with at least one processor, at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

Clause 5: The method of any of clauses 1-4, wherein the at least one micro drone is configured to return to and dock in or on the at least one scanning drone after executing the at least one set of micro drone operating instructions.

Clause 6: The method of any of clauses 1-5, wherein the at least one micro drone is configured to affix itself to a part of the train after executing the at least one set of micro drone operating instructions.

Clause 7: The method of any of clauses 1-6, further comprising: analyzing, with at least one processor, the primary inspection data to detect at least one abnormal train condition; and communicating, with at least one processor, at least one notification to at least one operator comprising a warning of the at least one abnormal train condition.

Clause 8: The method of any of clauses 1-7, further comprising: analyzing, with at least one processor, the secondary inspection data to detect at least one abnormal train condition; and communicating, with at least one processor, at least one notification to at least one operator comprising a warning of the at least one abnormal train condition.

Clause 9: The method of any of clauses 1-8, wherein the primary inspection data comprises at least visible light spectrum data, the method further comprising communicating, with at least one processor, at least a portion of the visible light spectrum data to a display device of at least one operator for real-time monitoring of the at least one scanning drone.

Clause 10: The method of any of clauses 1-9, further comprising automatically generating, with at least one processor, the travel path using at least one of the following: rail track geolocation data, environmental data, train consist data, or any combination thereof.

Clause 11: The method of any of clauses 1-10, further comprising storing, with at least one processor, the primary inspection data and/or the secondary inspection data in a non-transitory, computer-readable storage medium located onboard the at least one scanning drone or the train in a configuration to be later analyzed to detect at least one abnormal train condition.

Clause 12: A system for automatic inspection of a train comprising at least one locomotive and at least one railcar, the system comprising: at least one scanning drone comprising at least one sensor configured to obtain primary inspection data of the train comprising at least one of the following: infrared data, visible light spectrum data, temperature data, sample gas data, sound data, ultrasound data, x-ray data, LIDAR data, radar data, or any combination thereof; at least one server computer including at least one processor, the at least one server computer programmed and/or configured to: activate the at least one scanning drone; communicate at least one set of scanning drone operating instructions configured to cause the at least one scanning drone to obtain the primary inspection data along a travel path associated with the train; and receive the primary inspection data from the at least one sensor.

Clause 13: The system of clause 12, wherein the at least one scanning drone is configured to, when activated, deploy from a storage compartment positioned on or in the at least one locomotive or the at least one railcar, and wherein the at least one scanning drone is configured to return to the storage compartment after executing the at least one set of scanning drone operating instructions.

Clause 14: The system of clause 12 or 13, further comprising at least one micro drone comprising at least one sensor configured to obtain secondary inspection data of the train comprising at least one of the following: infrared data, visible light spectrum data, temperature data, sample gas data, sound data, ultrasound data, x-ray data, LIDAR data, radar data, or any combination thereof; wherein the at least one server computer is further programmed and/or configured to: activate the at least one micro drone; and communicate at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

Clause 15: The system of any of clauses 12-14, wherein the at least one server computer is further programmed and/or configured to: analyze the primary inspection data and/or the secondary inspection data to detect at least one abnormal train condition; and communicate at least one notification to at least one operator comprising a warning of the at least one abnormal train condition.

Clause 16: The system of any of clauses 12-15, wherein the at least one server computer is further programmed and/or configured to store the primary inspection data and/or the secondary inspection data in a non-transitory, computer-readable storage medium located onboard the at least one scanning drone or the train in a configuration to be later analyzed to detect at least one abnormal train condition.

Clause 17: A computer program product for automatic inspection of a train comprising at least one locomotive and at least one railcar, the computer program product comprising at least one non-transitory computer-readable medium including program instructions that, when executed by at least one processor, cause the at least one processor to: activate at least one scanning drone comprising at least one sensor configured to obtain primary inspection data of the train comprising at least one of the following: infrared data, visible light spectrum data, temperature data, sample gas data, sound data, ultrasound data, x-ray data, LIDAR data, radar data, or any combination thereof; communicate at least one set of scanning drone operating instructions configured to cause the at least one scanning drone to obtain the primary inspection data along a travel path associated with the train; and receive the primary inspection data from the at least one sensor.

Clause 18: The computer program product of clause 17, wherein the program instructions further cause the at least one processor to: activate at least one micro drone comprising at least one sensor configured to obtain secondary inspection data of the train comprising at least one of the following: infrared data, visible light spectrum data, temperature data, sample gas data, sound data, ultrasound data, x-ray data, LIDAR data, radar data, or any combination thereof; and communicate at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

Clause 19: The computer program product of clause 18, wherein the program instructions further cause the at least one processor to: analyze the primary inspection data and/or the secondary inspection data to detect at least one abnormal train condition; and communicate at least one notification to at least one operator comprising a warning of the at least one abnormal train condition.

Clause 20: The computer program product of clause 18 or 19, wherein the program instructions further cause the at least one processor to store the primary inspection data and/or the secondary inspection data in a non-transitory, computer-readable storage medium located onboard the at least one scanning drone or the train in a configuration to be later analyzed to detect at least one abnormal train condition.

### BRIEF DESCRIPTION OF THE DRAWINGS

These and other features of the present disclosure will become more apparent from the following description in which reference is made to the appended drawings wherein:

FIG. 1 is a schematic diagram of non-limiting embodiments or aspects of a system and method for automatic inspection of a train;

FIG. 2 is a schematic diagram of non-limiting embodiments or aspects of a system and method for automatic inspection of a train;

FIG. 3 is a schematic diagram of non-limiting embodiments or aspects of a system and method for automatic inspection of a train;

FIG. 4 is a schematic diagram of non-limiting embodiments or aspects of a system and method for automatic inspection of a train;

FIG. 5 is a network diagram of non-limiting embodiments or aspects of a system and method for automatic inspection of a train;

FIG. 6 is a flow diagram of non-limiting embodiments or aspects of a system and method for automatic inspection of a train; and

FIG. 7 is a flow diagram of non-limiting embodiments or aspects of a system and method for automatic inspection of a train.

### DETAILED DESCRIPTION

Various non-limiting examples will now be described with reference to the accompanying figures where like reference numbers correspond to like or functionally equivalent elements.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary embodiments or aspects of the disclosure. Hence, the specific embodiments or aspects disclosed herein are not to be construed as limiting. Also, it should be understood that any numerical range recited herein is intended to include all sub-ranges subsumed therein. For example, a range of 1 to 10 is intended to include all sub-ranges between (and including) the recited minimum value of 1 and the recited maximum value of 10, that is, having a minimum value equal to or greater than 1 and a maximum value of equal to or less than 10.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible. Any known electronic communication protocols and/or algorithms may be used such as, for example, TCP/IP (including HTTP and other protocols), WLAN (including 802.11 and other radio frequency-based protocols and methods), analog transmissions, Global System for Mobile Communications (GSM), and/or the like.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices.

As used herein, the term “server” may refer to or include one or more processors or computers, storage devices, or similar computer arrangements that are operated by or facilitate communication and processing for multiple parties in a network environment, such as the internet. In some non-limiting embodiments or aspects, communication may be facilitated over one or more public or private network environments and that various other arrangements are possible. Further, multiple computers, e.g., servers, or other computerized devices, e.g., mobile devices, directly or indirectly communicating in the network environment may constitute a system, such as a remote train and drone control system. Reference to a server or a processor, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the method, system, and computer program product described herein improve over existing inspection methods by providing a non-manual, more efficient, and more precise solution to train inspection. It will be appreciated that “inspection,” as used herein, encompasses all motivations for surveying/detecting/identifying trains, locomotives, and railcars, including, but not limited to: suspected malfunctions, derailment, train damage, railcar cataloging, train identification, traffic controlling, and/or the like. Through coordination of one or more scanning drones, and the optional deployment of one or more micro drones from the scanning drones, a thorough and accurate inspection of the train may be achieved in a fraction of the time required by a train operator's visual inspection. Moreover, drone-derived sensor data is not prone to the distractions or misperceptions of personnel, and based on the types of sensors onboard the drones, a wider variety of data may be used for the inspection. Because non-limiting embodiments or aspects provide for drones that can fly around the train itself, the range and scope of inspection greatly exceeds that capable by manual inspection. Furthermore, the described train inspection is versatile, such that the drones may be controlled manually or automatically, based on onboard flight instructions and/or instructions communicated to the drones from a controller. Inspection data may be analyzed in real-time, by personnel or computers, to detect abnormal train conditions (e.g., damaged components, broken equipment, malfunctioning equipment, dangerous environmental conditions, track/vehicular obstructions, leaks, coupling errors, track/railcar misalignments, unsafe temperature ranges, the presence of unsafe gas/liquids, and/or the like). The inspection data may also be useful to automatically identify and catalog a train by locomotive and railcar identifiers that are detectable from a drone. Sensor data may also be stored onboard the drones or communicated to storage devices remote from the drones, for later review/logging, providing additional layers of verifiability. Many additional improvements are described and provided in the detailed non-limiting embodiments or aspects below.

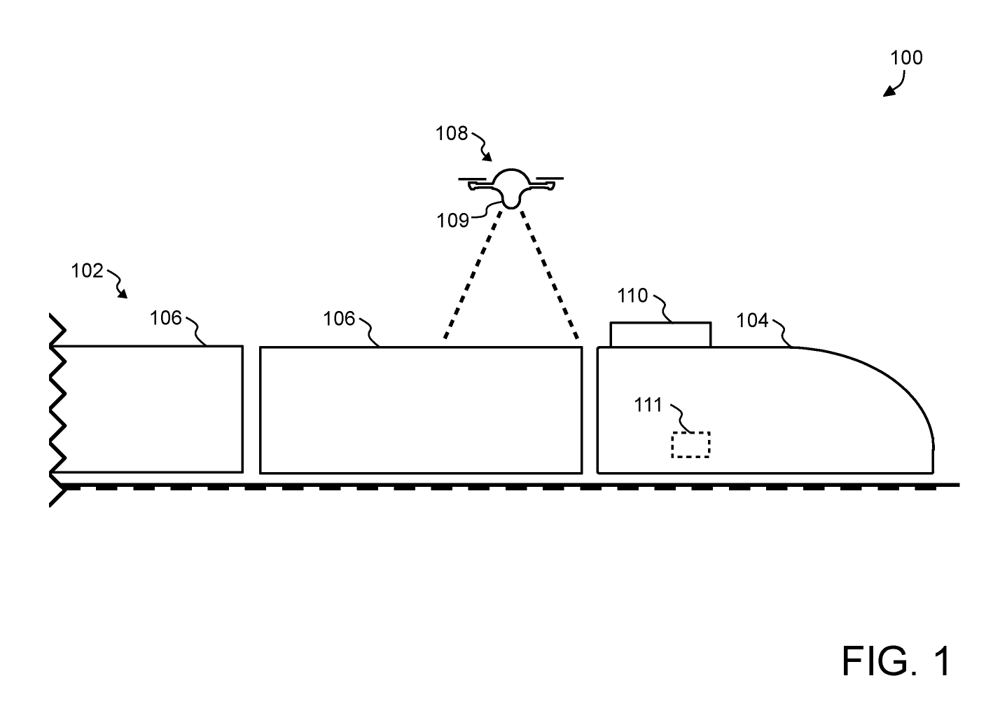

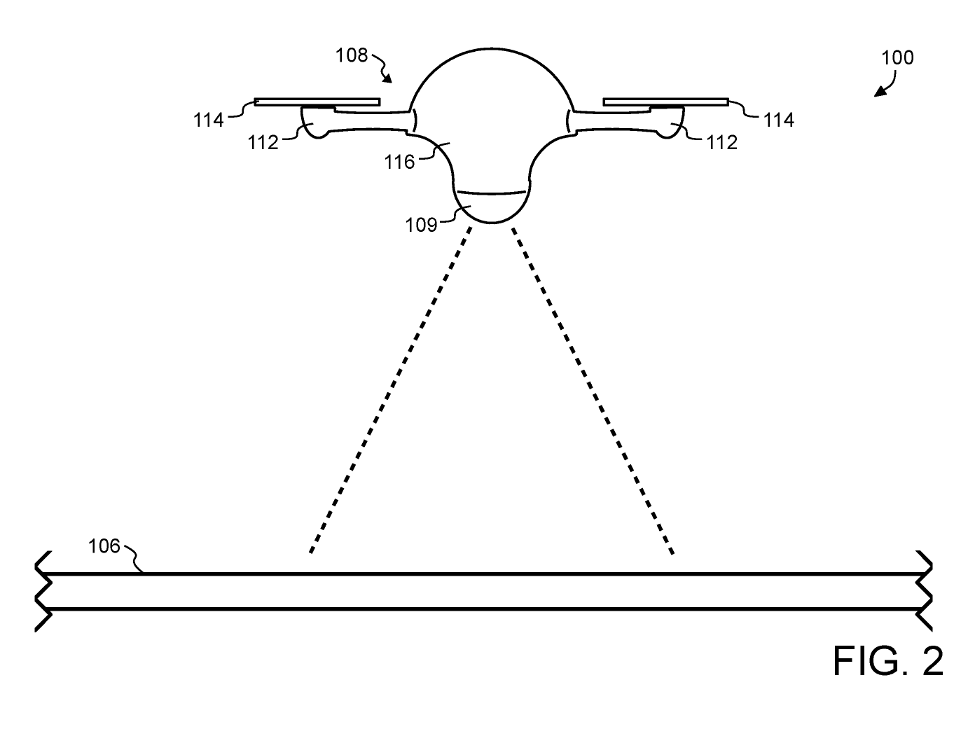

With specific reference to FIGS. 1 and 2, and in non-limiting embodiments or aspects, provided is a system 100 for automatic inspection of a train 102. The train 102 may include a locomotive 104 and one or more railcars 106. The locomotive 104 may be any adequate train vehicle that provides motive power for the train 102, e.g., an internal combustion engine, an electric locomotive, a hybrid locomotive, and/or the like. A railcar 106 may be any vehicular subunit of the train 102, including, but not limited to, a passenger car, a freight car, a military car, and/or the like. Also provided are one or more scanning drones 108 having at least one sensor 109 configured to capture inspection data of the train 102. It will be appreciated that the term “scanning” should not be taken to limit the function or size of the drone, and that “scanning” is meant to convey the general purpose of the drone to collect sensed inspection data from a train. The sensor 109 (or multiples thereof) may include, but is not limited to, an infrared sensor, a visible light spectrum photo-sensor, a temperature sensor, a sample gas sensor, a sound sensor, an ultrasound sensor, an infrasound sensor, an x-ray sensor, a LIDAR sensor, a radar sensor, and/or the like. The sensor 109 may be a composite of one or more sensors. The scanning drone 108 may include a propulsion system, having one or more power supplies (e.g., battery, fuel, and/or the like) and one or more thrust and/or lift mechanisms (e.g., aerofoil, motor/engine, propeller, jets, turbines, and/or the like), and may further include one or more transceivers for drone control and/or data communication, as well as an onboard memory for the collection/storage of data. The scanning drone 108 may be configured to be launched from on the train 102, near the train 102, or a remote location from the train 102. For non-limiting embodiments or aspects where the scanning drone 108 is launched from the train 102, the scanning drone 108 may be stored (when not in flight) in an on-train storage compartment 110, which may include a charging station, a dock, an enclosure, a locking mechanism, a data connection, and/or the like. The storage compartment 110 may be positioned on the locomotive 104 as pictured, or otherwise in the locomotive 104, or on/in another portion of the train 102, such as one of the railcars 106. For non-limiting embodiments or aspects employing more than one scanning drone 108, one or more storage compartments 110 may be used to house one or more scanning drones 108. It will be appreciated that many configurations are possible.

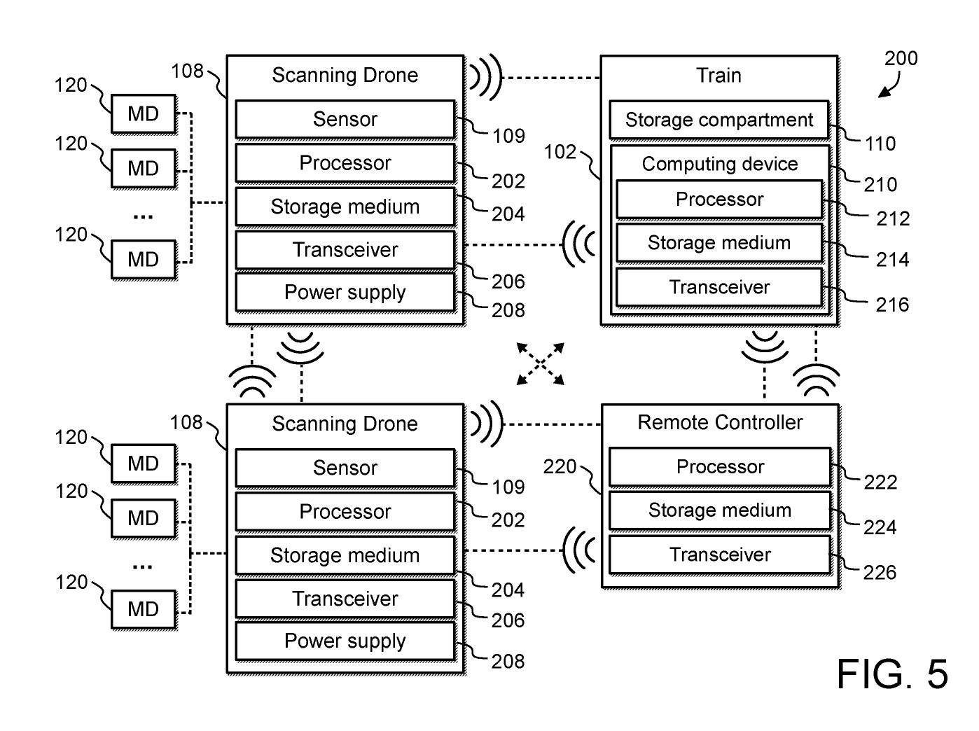

With further reference to FIGS. 1 and 2, a drone controller 111 may be provided in non-limiting embodiments or aspects where the operating instructions of the scanning drone 108 are at least partially remotely controlled/configured. The drone controller 111 may include at least one processor and at least one transceiver. The drone controller 111 may be automatically controlled, manually controlled, or a combination thereof. If the drone controller 111 is at least partially manually controlled, an involved personnel may be located on site with the train (e.g., in the locomotive, outside the locomotive near the track, etc.) or at a remote location, and the drone controller 111 may further include controls for human interfacing. The drone controller 111 may be a computing device positioned on the train 102, as represented by element 210 in FIG. 5, may be a remote controller not positioned on the train 102, as represented by element 220 in FIG. 5, or may be a combination of such devices working in concert. A drone controller may further be a mobile device, such as one operated by train personnel. Many configurations are possible. The drone controller 111 may communicate flight instructions to the scanning drone 108, or flight instructions may be pre-programmed therein, to provide a flight path for the scanning drone 108 to travel, such as at a predetermined height above and along the length of the train 102. The flight path may be automatically determined based on geolocation data and/or track data, provided from a network connection (e.g., such as with a control center, like a train dispatch or back office), provided from a storage device (e.g., on the train 102 or the drone controller 111), and/or the like. In non-limiting embodiments or aspects, the scanning drone 108 may travel along the flight path corresponding to the track position of the locomotive 104 and/or railcars 106, above and/or to the side of the railcars 106, using its sensor 109 to detect abnormal train 102 conditions, identify railcars, and/or catalog train condition. The scanning drone 108 may provide human-augmented inspection. For instance, the scanning drone 108 may communicate inspection data in real-time, or substantially real-time, for viewing by an operator located onboard the locomotive 104. This may further allow the operator to request an inspection of a particular railcar 106 or region around the particular railcar 106. In further non-limiting embodiments or aspects, the inspection data may be communicated to a remote location for viewing by personnel (e.g., an inspection expert), where the personnel may be able to request inspection of a particular railcar 106 or region around the particular railcar 106.

With further reference to FIGS. 1 and 2, different sensor 109 types may be useful for detecting different abnormal train 102 conditions. For example, an infrared sensor or a temperature sensor may be used for imaging a train 102 at night, and further detecting areas of abnormally high heat (e.g., such as caused by a fire, heated brakes, wheel wear, etc.), which may be dangerous to passengers, the train 102, explosive cargo, and/or the like. A visible light spectrum photo-sensor may be used for visual analysis, by personnel and/or feature-detection machine learning, to detect decoupled railcars 106, damage to railcars 106, leaks, cargo breaches, obstacles/obstructions, disconnected trainlines, and/or the like. A sample gas sensor may be used for the detection of gases (e.g., toxic gases, explosive gases, etc.) in the area of the train 102, such as may be caused by a gas leak on or near the train 102, a gaseous environment around the train 102, and/or the like. A sound sensor (which may be understood herein to encompass any and all wavelengths of sound waves, whether or not audible to humans), an ultrasound sensor, and/or an infrasound sensor may be used to detect sounds or noises and/or produce imaging indicative of broken train 102 components, passengers (e.g., in a rescue operation or detecting obstacles), leaks, and/or the like. An x-ray sensor, a LIDAR sensor, or a radar sensor may be used for sub-surface, depth, or positional imaging to detect damage, wear, fatigue, leaks, breaches, obstacles/obstructions, disconnections, and/or the like where traditional visual spectrum imaging may not suffice or provide accurate readings. It will be appreciated that there are many types of sensors and configurations for detecting and sensing train conditions.

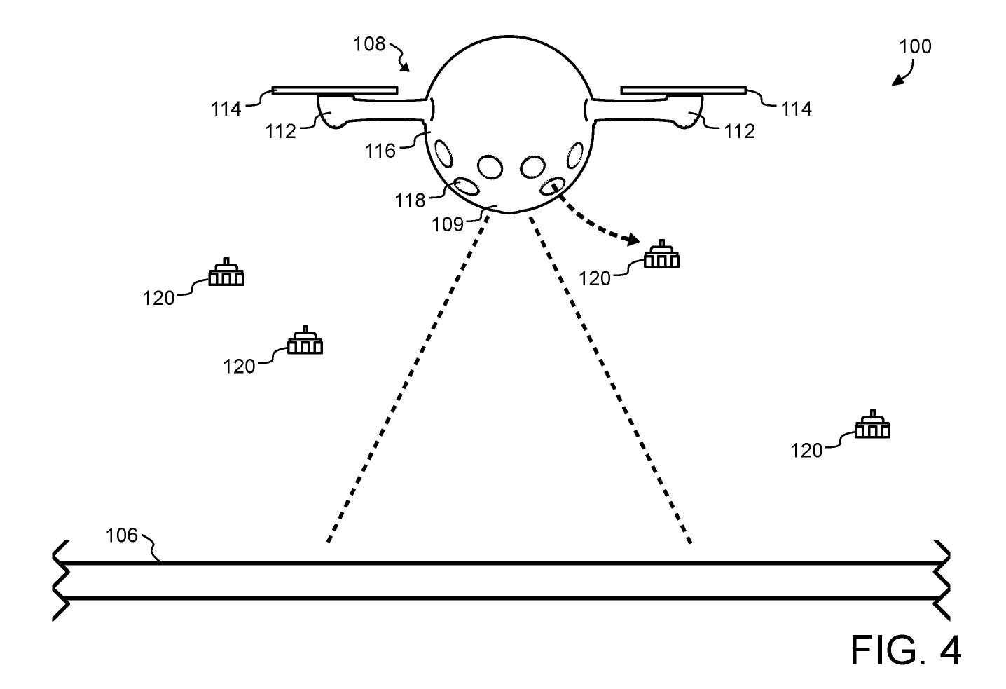

With further reference to FIG. 2, in further non-limiting embodiments or aspects, the scanning drone 108 may have one or more armatures 112 connected to one or more propellers 114 powered by motors to control the flight of the drone 108. The armatures 112 may be connected to the housing 116 of the drone 108, which may enclose one or more processors, transceivers, data storage mediums, power supplies, motors, and/or sensors 109. The scanning drone 108 may be programmed/configured to return to its launch point or storage compartment after executing the operating instructions for flight and/or inspection data collection. The scanning drone 108 may include other features not pictured, such as support legs for landing, antenna, external cameras, and/or the like. An alternative non-limiting embodiment of a scanning drone 108 is also shown in detail in FIG. 4. It will be appreciated that many configurations are possible.

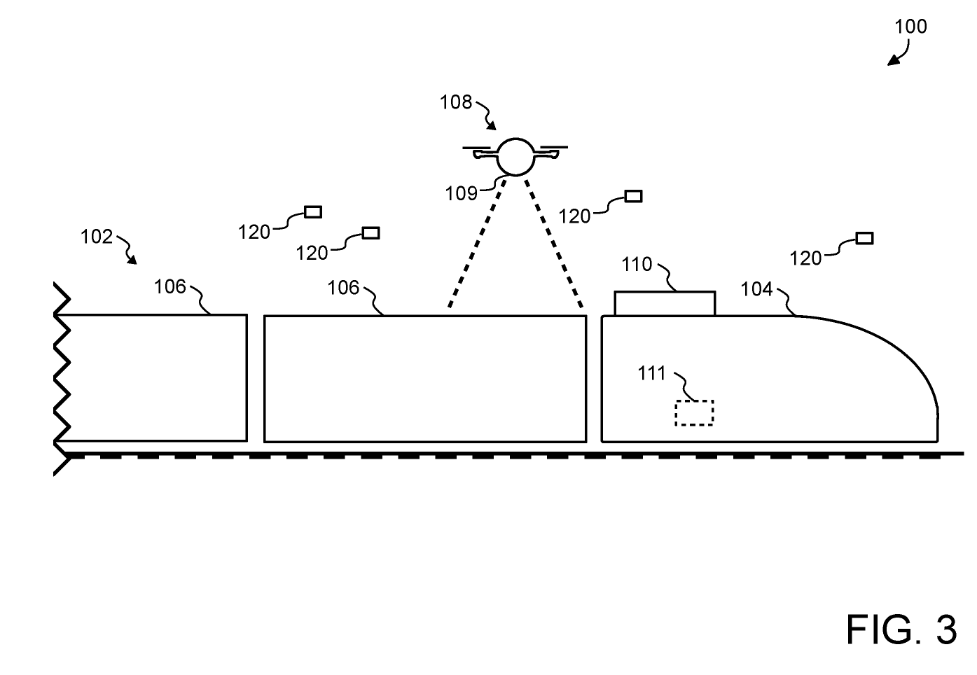

With specific reference to FIGS. 3 and 4, and in non-limiting embodiments or aspects, provided is a system 100 for automatic inspection of a train 102. The train 102 may include a locomotive 104 and one or more railcars 106. Also provided are one or more scanning drones 108 having at least one sensor 109 configured to capture inspection data of the train 102. A sensor 109 may be a composite of one or more sub-sensors. The scanning drone 108 may include a propulsion system, having one or more power supplies (e.g., battery, fuel, and/or the like) and one or more thrust and/or lift mechanisms (e.g., aerofoil, motor/engine, propeller, jets, turbines, and/or the like), and may further include one or more transceivers for drone control and/or data communication, as well as an onboard memory for the collection/storage of data. The depicted scanning drone 108 is further configured to contain and release one or more micro drones 120, for secondary inspection of the train 102. Secondary inspection may be useful to detect/sense conditions not identified during primary inspection. It will be appreciated that “micro” should not be taken as limiting on the size or functionality of the drone, and “micro” is meant to convey the relative smaller size of the micro drone as compared to the scanning drone. The micro drones 120 may include a same or different type of propulsion system as the scanning drone 108, and may further include one or more transceivers for micro drone 120 control and/or data communication, as well as an onboard memory for the collection/storage of data. The micro drones 120 may include one or more sensors, which may include, but are not limited to, an infrared sensor, a visible light spectrum photo-sensor, a temperature sensor, a sample gas sensor, a sound sensor, an ultrasound sensor, an infrasound sensor, an x-ray sensor, a LIDAR sensor, a radar sensor, and/or the like. Micro drones 120 may also be stored and launched remotely from a scanning drone. It will be appreciated that other secondary inspection devices may be used and deployed from a scanning drone 108 besides micro drones 120, including mobile robotic sensing devices that locomote by one or more means such as crawling, rolling, flying and/or the like (e.g., robotic rovers, spiders, dragonflies, micro-vehicles, etc.). The scanning drone 108 may be configured to be launched from on the train 102, near the train 102, or a remote location from the train 102. For non-limiting embodiments or aspects where the scanning drone 108 is launched from the train 102, the scanning drone 108 may be stored (when not in flight) in an on-train storage compartment 110. The storage compartment 110 may be positioned on the locomotive 104 as pictured, or otherwise in the locomotive 104, or on/in another portion of the train 102, such as one of the railcars 106. For non-limiting embodiments or aspects having more than one scanning drone 108, one or more storage compartments 110 may be used to house one or more scanning drones 108. Storage compartments 110 may also be provided for one or more micro drones 120. It will be appreciated that many configurations are possible.

With further reference to FIGS. 3 and 4, a drone controller 111 may be provided in non-limiting embodiments or aspects where the operating instructions of the scanning drone 108 are remotely controlled/configured. The drone controller 111 may include at least one processor and at least one transceiver. The drone controller 111 may be automatically controlled, manually controlled, or a combination thereof. If at least partially manually controlled, an involved personnel may be located on site with the train or at a remote location. The drone controller 111 may be a computing device positioned on the train 102, as represented by element 210 in FIG. 5, may be a remote controller not positioned on the train 102, as represented by element 220 in FIG. 5, or may be a combination of such devices working in concert. Many configurations are possible. The drone controller 111 may communicate flight instructions to the scanning drones 108 and/or the micro drones 120, to provide flight paths for the scanning drones 108 and/or micro drones 120 to travel, such as at a predetermined height above and along the length of the train 102. The flight paths may be automatically determined based on geolocation data and/or track data, provided from a network connection (e.g., such as with a control center, like a train dispatch or back office), provided from a storage device (e.g., on the train 102 or the drone controller 111), and/or the like. Scanning drones 108 and micro drones 120 may have different flight paths, and the comparatively smaller size of the micro drones 120 may allow the micro drones 120 to navigate spaces and environments not accessible to the scanning drones 108. In non-limiting embodiments or aspects, the scanning drones 108 and/or micro drones 120 may travel along respective flight paths corresponding to the track position of the locomotive 104 and/or railcars 106, above and/or to the side of the railcars 106, using sensors to detect train 102 conditions.

With further reference to FIGS. 3 and 4, in further non-limiting embodiments or aspects, the scanning drone 108 may have one or more armatures 112 connected to one or more propellers 114 powered by motors to control the flight of the drone 108. The armatures 112 may be connected to the housing 116 of the drone 108, which may enclose one or more processors, transceivers, data storage mediums, power supplies, motors, and/or sensors 109. The scanning drone 108 may be programmed/configured to return to its launch point or storage compartment after executing the operating instructions for flight and/or inspection data collection. The scanning drone 108 may further include one or more docks 118 for deployment of micro drones 120. The docks 118 may take the form of enclosed compartments, connectors, external latches, chutes, hatches, cubbies, and/or the like. Micro drones 120 may also be stored and launched remotely from a scanning drone 108. It will be appreciated that other secondary inspection devices may be used and deployed from a scanning drone 108 besides micro drones 120, including mobile robotic sensing devices that locomote by one or more means such as crawling, rolling, flying and/or the like (e.g., robotic rovers, spiders, dragonflies, micro-vehicles, etc.). After the micro drones 120 are activated, the micro drones 120 may employ one or more sensors to obtain secondary inspection data of the train 102 including, but not limited to, at least one of the following: infrared data, visible light spectrum data, temperature data, sample gas data, sound data, ultrasound data, x-ray data, LIDAR data, radar data, or any combination thereof. The micro drones 120 may receive a set of micro drone operating instructions (either pre-programmed or communicated in real-time), which may be variable by micro drone 120, configured to cause the micro drones to: deploy, fly/navigate, inspect the train 102, generate the secondary inspection data, or any combination thereof. The micro drones 120 may be configured to return to and dock in or on a scanning drone 108 (either the scanning drone 108 from which the micro drone 120 was launched, or another) after executing the micro drone 120 operating instructions. The micro drones 120 may also be configured to affix to a part of the train 102 after executing the at least one set of micro drone 120 operating instructions. In a non-limiting example, a micro drone 120 may include a magnet, a suction cup, a vice, an adhesive, a physical connector, a magnetic-attractive material, and/or the like to connect to a railcar, a locomotive, or another component of the train. In further non-limiting embodiments or aspects, the micro drones 120 may travel to and complete their flight at a location not associated with the train 102 or scanning drones 108. The scanning drones 108 and micro drones 120 may include other features not pictured, such as support legs for landing, external cameras, and/or the like. An alternative non-limiting embodiment of a scanning drone 108 is also shown in detail in FIG. 2. It will be appreciated that many configurations are possible.

With specific reference to FIG. 5, and in non-limiting embodiments or aspects, provided is a network 200 of a system for automatic inspection of a train 102. It is to be understood that “automation” may refer to flight, collection of data, analysis of data, an aspect of the inspection operation, and/or the like. Dashed lines represent communicative connections (persistent or non-persistent), which may each be in the same communication channel, separate communication channels, or a combination thereof. The network 200 includes one or more scanning drones 108, each of which may include a sensor 109, a processor 202, a data storage medium 204, a transceiver 206, and a power supply 208. Each scanning drone 108 may be communicatively connected to one or more micro drones 120. Scanning drones 108 may temporarily house micro drones 120 prior to inspection flights, or micro drones 120 may be housed and launched separately therefrom. Each scanning drone 108 may also be communicatively connected to the train 102. The train 102 may include one or more storage compartments 110 for housing the one or more scanning drones 108 and/or micro drones 120. The train 102 may also include a computing device 210, which may optionally act as a drone controller. The computing device 210 onboard the train 102 may include a processor 212, a data storage medium 214, and a transceiver 216 for communicative connection to an onboard database, a remote controller 220, the scanning drones 108, and/or the micro drones 120. The network 200 may also include a remote controller 220 (e.g., a communicatively connected computing device) to act as a drone controller. The remote controller 220 may include a processor 222, a data storage medium 224, and a transceiver 226 for communicative connection to the train 102, the scanning drones 108, and/or the micro drones 120. Many configurations are possible.

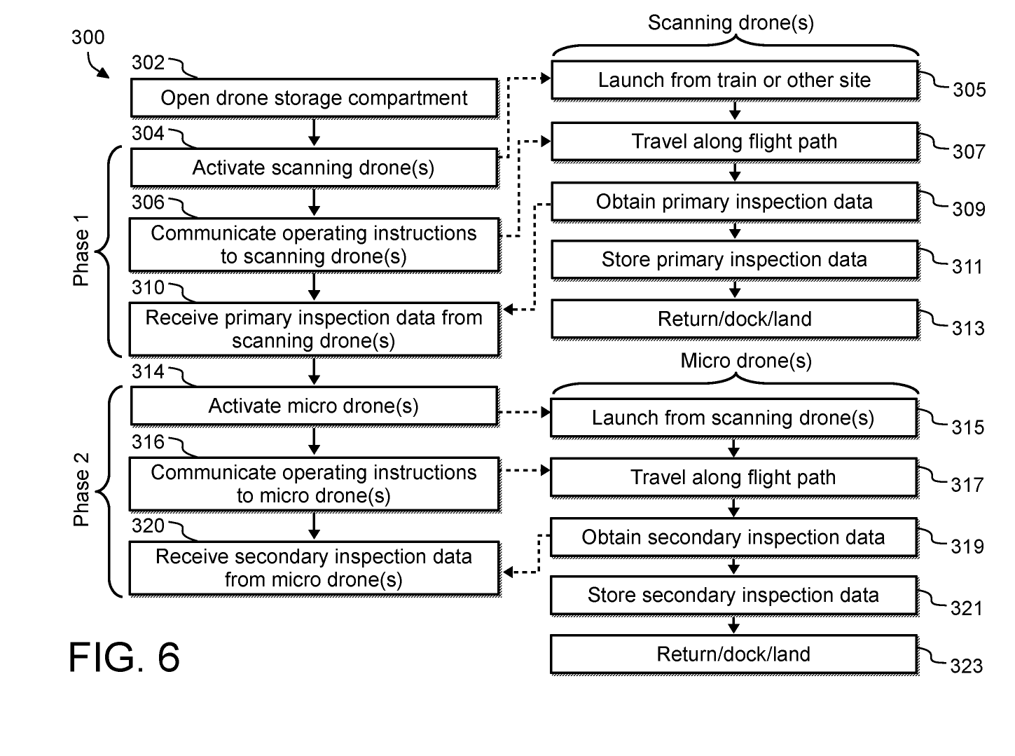

With specific reference to FIG. 6, and in non-limiting embodiments or aspects, provided is a method 300 for automatic inspection of a train. It is to be understood that “automation” may refer to flight, collection of data, analysis of data, an aspect of the inspection operation, and/or the like. Steps 302, 304, 306, 310, 314, 316, and 320 may be conducted by a drone controller, such as a locomotive computing device or a remote controller, or another computing device/server. Steps 305, 307, 309, 311, and 313 may be carried out by one or more scanning drones. Steps 315, 317, 319, 321, and 323 may be carried out by one or more micro drones. The various described steps may overlap or be sequenced other than depicted in FIG. 6, as provided by the descriptions and non-limiting embodiments or aspects herein.

With further reference to FIG. 6, and in further non-limiting embodiments or aspects, in step 302, a drone storage compartment may be opened to allow for the launch of one or more scanning drones. The drone storage compartment may be positioned on the train itself. Multiple scanning drones may be stored in the same drone storage compartment. Some non-limiting embodiments or aspects may include multiple drone storage compartments, while others may not include a drone storage compartment. Step 302 may be completed automatically by actuators in response to a signal from the drone controller. In step 304, the one or more scanning drones are activated. Activation may be triggered in response to personnel input (e.g., a locomotive operator command) or may be automatically triggered (e.g., in response to activation of the train's brakes, when a mechanical failure is detected, etc.). A subset of the available scanning drones may be activated for a given inspection process. Activation may be automatic in reaction to the drone storage compartment being opened in step 302. Activation may also be manually triggered. Drone startup steps (e.g., motor testing, gyroscope testing, sensor testing, etc.) may require external prompting, or it may be pre-programmed. In step 305, the one or more scanning drones launch (e.g., take flight) from the train or another launch site, such as a pad next to the train, a carrying case, the ground, a road-rail vehicle, and/or the like. In step 306, operating instructions are communicated to the scanning drone. The operating instructions may also be pre-programmed in a data storage medium of the scanning drone. The operating instructions may include instructions regarding flight path, navigation parameters (e.g., speed, height, energy usage, etc.), inspection parameters (e.g., number of rail cars, sensor data type, areas for inspection, etc.), and/or the like. The operating instructions may be customized for each scanning drone deployed, and areas of inspection by each scanning drone may overlap. In response, in step 307, each deployed scanning drone travels along its flight path, and in step 309, each deployed scanning drone may obtain primary inspection data via its onboard sensor(s), including, but not limited to: infrared data, visible light spectrum data, temperature data, sample gas data, sound data, ultrasound data, x-ray data, LIDAR data, radar data, or any combination thereof.

With further reference to FIG. 6, and in further non-limiting embodiments or aspects, in step 310, the drone controller (or other operative computing device/server) may receive the primary inspection data for display, analysis, storage, and/or the like. If the primary inspection data includes captured images or video, the images or video may be shown on a display of the drone controller for visual feedback to operating personnel. Image/video data may be displayed to personnel using virtual reality or augmented reality headsets/goggles for added immersion and detailed observation. The primary inspection data may be automatically analyzed for abnormal train conditions by the drone controller. The primary inspection data may also be communicated to a remote server or the event data recorder onboard the locomotive for storage and analysis. Stored data may be used for historic analysis and further training machine learning models to better automatically detect abnormal conditions. In other words, each past inspection may strengthen subsequent inspections because the system as a whole has learned something more from each past inspection. Offloaded data, either in real-time or after drone flight, may be stored in a cloud storage network. Personnel may also interpret the primary inspection data for abnormalities as presented to them on one or more display devices. In step 311, the one or more scanning drones may store the primary inspection data onboard the respective scanning drone in a data storage medium for later retrieval. In step 313, the one or more scanning drones return to their launch sites, return to docks on or in the train (e.g., in the storage compartment), land away from the train, and/or the like.

With further reference to FIG. 6, and further non-limiting embodiments or aspects, in step 314, one or more micro drones are activated. A subset of the available micro drones may be activated for a given inspection process. Activation may include all micro drones, all of the micro drones from a subset of the scanning drones, a subset of micro drones from all of the scanning drones, or a subset of micro drones from a subset of scanning drones. Micro drones may be activated independently from scanning drones. Activation may be automatic in reaction to micro drone docks of a scanning drone being opened/released. Micro drones may be pre-calibrated before being docked on a scanning drone. Micro drones may also be stored and launched remotely from a scanning drone. In step 315, the one or more micro drones launch (e.g., take flight) from their respective scanning drone or launch site. In step 316, operating instructions are communicated to the micro drone, such as directly from a drone controller or from an associated scanning drone. The operating instructions may also be pre-programmed in a data storage medium of the micro drone. The operating instructions may include instructions regarding flight path, navigation parameters (e.g., speed, height, energy usage, etc.), inspection parameters (e.g., number of rail cars, sensor data type, areas for inspection, etc.), and/or the like. The operating instructions may be customized for each micro drone deployed, and areas of inspection by each micro drone may overlap. In response, in step 317, each deployed micro drone travels along its flight path, and in step 319, each deployed micro drone may obtain secondary inspection data via its onboard sensor(s), including, but not limited to: infrared data, visible light spectrum data, temperature data, sample gas data, sound data, ultrasound data, x-ray data, LIDAR data, radar data, or any combination thereof.

With further reference to FIG. 6, and in further non-limiting embodiments or aspects, in step 320, the drone controller (or other operative computing device/server) may receive the secondary inspection data for display, analysis, storage, and/or the like. If the secondary inspection data includes captured images or video, the images or video may be shown on a display of the drone controller for visual feedback to operating personnel. Image/video data may be displayed to personnel (e.g., personnel onboard the locomotive and/or at a remote site, simultaneously or non-simultaneously), using virtual reality or augmented reality headsets/goggles for added immersion and detailed observation. The secondary inspection data may be automatically analyzed for abnormal train conditions by the drone controller. The secondary inspection data may also be communicated to a remote server for storage and analysis. Stored data may be used for historic analysis and further training machine learning models to better automatically detect abnormal conditions. Offloaded data, either in real-time or after drone flight, may be stored in a cloud storage network. Personnel may also interpret the secondary inspection data for abnormalities as presented to them on one or more display devices. In step 321, the one or more micro drones may store the secondary inspection data onboard the respective micro drone (or associated scanning drone) in a data storage medium for later retrieval. In step 323, each deployed micro drone returns to its launch site, docks on or in an associated scanning drone, lands away from the train, and/or the like. It will be appreciated that many configurations are possible.

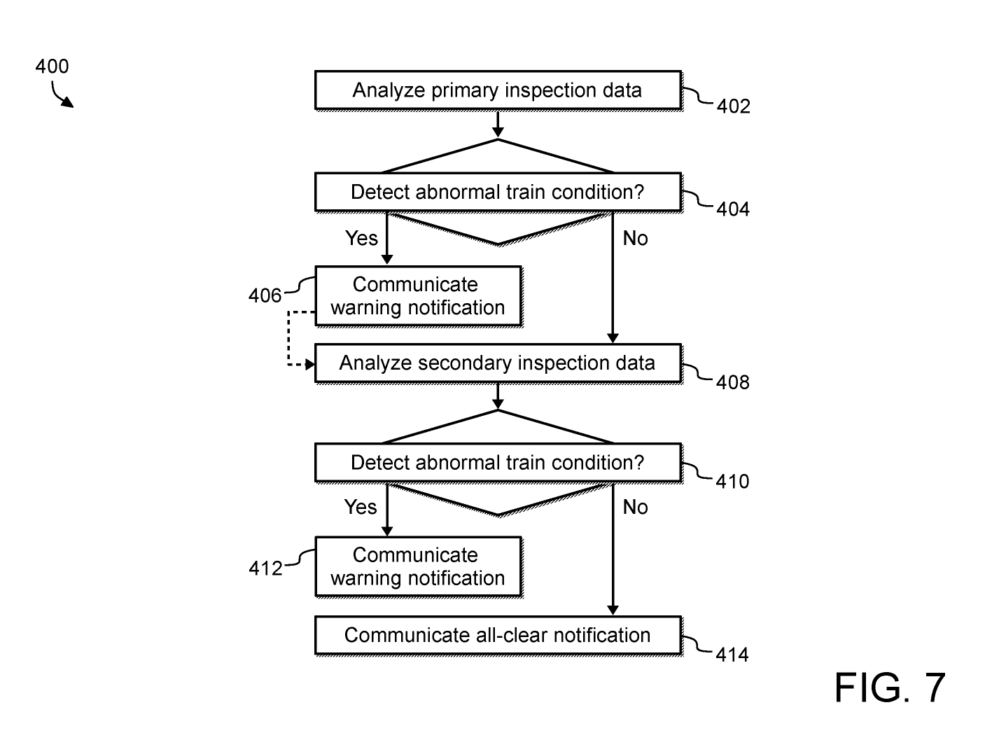

With specific reference to FIG. 7, and in non-limiting embodiments or aspects, provided is a method 400 for automatic inspection of a train. It is to be understood that “automation” may refer to flight, collection of data, analysis of data, an aspect of the inspection operation, and/or the like. The depicted steps may be carried out by one or more processors, such as a drone controller, which may be a locomotive computing device or a remote controller, or another computing device/server. The depicted steps may also be divided over one or more communicatively connected processors positioned in one or more locations. In step 402, primary inspection data is received from the one or more deployed scanning drones and is analyzed. In this step, the primary inspection data may be segmented and displayed to personnel to show the inspection data corresponding to each railcar in the train consist. The primary inspection data may be formatted for review by personnel, such as presented in charts or graphs, and in the case of video/audio inspection data in the ranges of human perception, the video/audio inspection data may be played back for a reviewing personnel. Playback/display of primary inspection data may be in real-time with the collection of the primary inspection data by the sensors of the scanning drones, while the scanning drones are in flight. In step 402, the analysis of the primary inspection data may be conducted automatically, such as through machine learning algorithms and/or threshold comparisons based on historic inspection data. In a non-limiting example, image-based machine learning algorithms may be employed to identify railcar couplers that are unconnected, physical damage to railcars, track obstructions, and/or the like. In another non-limiting example, sensor values may be compared to predetermined threshold levels indicative of a danger, e.g., a gas sensor may compare a sampled particulate count of toxic/explosive gas to a threshold particulate count of toxic/explosive gas. It will be appreciated that many configurations are possible.

With further reference to FIG. 7, and in further non-limiting embodiments or aspects, abnormal train conditions are detected from the primary inspection data, if present, in step 404. Detection of abnormal train conditions may be determined automatically by a computing device, may be manually determined, or a combination thereof. In a non-limiting example, a computing device may identify one or more portions of the primary inspection data indicative of possible abnormal train conditions and flag the portions for further personnel review (e.g., isolate one or more images showing potential trainline brakes and where they are located). If an abnormal train condition is detected automatically by the system, a warning notification may be broadcast to personnel in step 406. The warning notification may be communicated to a drone controller, a locomotive computing device, a remote server (e.g., a dispatch center or back office system), an operator communication device (e.g., a mobile device), and/or the like. Because the system may automatically identify and isolate potential abnormalities from the primary inspection data, personnel may focus their attention on a fraction of the train consist instead of manually inspecting the entirety of the train.

With further reference to FIG. 7, and in further non-limiting embodiments or aspects, in step 408, secondary inspection data is received from the one or more deployed micro drones and is analyzed. Secondary inspection data may be analyzed before primary inspection data, and either form of inspection data may be omitted from an analysis process to expedite review. Secondary inspection data may be corresponded to primary inspection data (e.g., by matching geolocation, railcar identifier, timestamp, etc.) to provide alternative/detailed analysis of the same segment of the train or inspection process. In step 408, the secondary inspection data may be segmented and displayed to personnel to show the inspection data corresponding to each railcar in the train consist. The secondary inspection data may be formatted for review by personnel, such as presented in charts or graphs, and in the case of video/audio inspection data in the ranges of human perception, the video/audio inspection data may be played back for a reviewing personnel. Playback/display of secondary inspection data may be in real-time with the collection of the secondary inspection data by the sensors of the micro drones while the micro drones are in flight. In step 408, the analysis of the secondary inspection data may be conducted automatically, such as through machine learning algorithms and/or threshold comparisons based on historic inspection data. In a non-limiting example, image-based machine learning algorithms may be employed to identify railcar couplers that are unconnected, physical damage to railcars, track obstructions, and/or the like. In another non-limiting example, sensor values may be compared to predetermined threshold levels indicative of a danger, e.g., a gas sensor may compare a sampled particulate count of toxic/explosive gas to a threshold particulate count of toxic/explosive gas. It will be appreciated that many configurations are possible.

With further reference to FIG. 7, and in further non-limiting embodiments or aspects, abnormal train conditions are detected from the secondary inspection data, if present, in step 410. Detection of abnormal train conditions may be determined automatically by a computing device, may be manually determined, or a combination thereof. In one non-limiting example, a computing device may identify one or more portions of the secondary inspection data indicative of possible abnormal train conditions and flag the portions for further personnel review (e.g., isolate one or more images showing potential trainline brakes and where they are located). If an abnormal train condition is detected automatically by the system, a warning notification may be broadcast to personnel in step 412. The warning notification may be communicated to a drone controller, a locomotive computing device, a remote server (e.g., a dispatch center or back office system), an operator communication device (e.g., a mobile device), and/or the like. Because the system may automatically identify and isolate potential abnormalities from the secondary inspection data, personnel may focus their attention on a fraction of the train consist instead of manually inspecting the entirety of the train. If no abnormal train conditions are detected, the system may communicate an all-clear notification to a communication device and/or the drone controller, in step 414, which may include, but is not limited to: a text communication, an audio communication, an image/video communication, an indicator light, and/or the like. Many configurations are possible.

With further reference to the foregoing figures, and in further non-limiting embodiments or aspects, described systems and methods may be applied to trains in any inspection environment, including, but not limited to: along a rail line while the train is moving, along a rail line while the train is stopped, and in a closed yard having one or more trains (e.g., a storage yard, a holding yard, a hump yard, etc.). Moreover, the sensors of the scanning drones and/or micro drones may include radio frequency identification (RFID) or other like sensors to identify railcars and/or cargo. For example, each railcar may be provided with an automatic equipment identification (AEI) tag, and as a scanning drone and/or micro drone surveys a train consist, each railcar may be identified, located, and/or cataloged. In this manner, the position of a train, the composition of a train, and/or the like may be determined. Moreover, in response to receiving primary inspection data and/or secondary inspection data, one or more train actions can be taken, by at least one processor, including deactivating a power supply, communicating a warning notification (e.g., on a display, an indicator light, in a mobile device text transmission), charging a brake line, testing connections to onboard communication devices, moving the locomotive and/or railcars along the track, and/or the like. It will be appreciated that many configurations are possible.

With further reference to the foregoing figures, and in further non-limiting embodiments or aspects, a scanning drone 108 may be deployed ahead of a train 102 (e.g., several hundred feet, a few miles, etc.) for inspection of a region and/or track, including while the train 102 is in motion. This may be triggered automatically or initiated by a locomotive operator or other personnel. The region and/or track may be analyzed for dangers/anomalies, and for systems including a scanning drone 108 launched from the train 102 itself, the scanning drone 108 may return and re-dock on the train 102 after completing its forward surveillance.

With further reference to the foregoing figures, and in further non-limiting embodiments or aspects, inspection data may include any number of one or more data types, including, but not limited to: infrared data, visible light spectrum data, temperature data, sample gas data, sound data, ultrasound data, x-ray data, LIDAR data, radar data, or any combination thereof. Along with inspection data, environmental data may also be detected (e.g., by scanning drones, micro drones, or sensors located on the train or other sensing devices). Environmental data may include, but is not limited to, weather conditions (e.g., wind speed, precipitation, etc.), ambient temperature, barometric pressure, humidity, and/or the like. Environmental data may also be provided by third party sources, such as remote sensors, weather stations, or meteorological database systems (e.g., including data of approaching storms or recently occurring storms in the area of the train/track). Inspection data may be correlated with environmental data, to increase the precision of readings and to strengthen forensic reviews of train inspection.

Although the method, system, and computer program product have been described in detail for the purpose of illustration based on what is currently considered to be the most practical and preferred embodiments or aspects, it is to be understood that such detail is solely for that purpose and that the method, system, and computer program product are not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method for automatic inspection of a train comprising at least one locomotive and at least one railcar, the method comprising:
activating, or causing the activation of, with at least one processor, at least one scanning drone comprising at least one sensor configured to obtain primary inspection data of the train comprising at least one of the following: infrared data, visible light spectrum data, temperature data, sample gas data, sound data, ultrasound data, x-ray data, LIDAR data, radar data, or any combination thereof;
communicating, with at least one processor, at least one set of scanning drone operating instructions configured to cause the at least one scanning drone to obtain the primary inspection data along a travel path associated with the train;
receiving, with at least one processor, the primary inspection data from the at least one sensor.

2. The method of claim 1, wherein activating, or causing the activation of, the at least one scanning drone comprises deploying the at least one scanning drone from a storage compartment positioned on or in the at least one locomotive or the at least one railcar.

3. The method of claim 2, wherein the at least one scanning drone is configured to return to the storage compartment after executing the at least one set of scanning drone operating instructions.

4. The method of claim 1, further comprising:
activating, or causing the activation of, with at least one processor, at least one micro drone comprising at least one sensor configured to obtain secondary inspection data of the train comprising at least one of the following: infrared data, visible light spectrum data, temperature data, sample gas data, sound data, ultrasound data, x-ray data, LIDAR data, radar data, or any combination thereof; and
communicating, with at least one processor, at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

5. The method of claim 4, wherein the at least one micro drone is configured to return to and dock in or on the at least one scanning drone after executing the at least one set of micro drone operating instructions.

6. The method of claim 4, wherein the at least one micro drone is configured to affix itself to a part of the train after executing the at least one set of micro drone operating instructions.

7. The method of claim 1, further comprising:
analyzing, with at least one processor, the primary inspection data to detect at least one abnormal train condition; and
communicating, with at least one processor, at least one notification to at least one operator comprising a warning of the at least one abnormal train condition.

8. The method of claim 4, further comprising:
analyzing, with at least one processor, the secondary inspection data to detect at least one abnormal train condition; and
communicating, with at least one processor, at least one notification to at least one operator comprising a warning of the at least one abnormal train condition.

9. The method of claim 1, wherein the primary inspection data comprises at least visible light spectrum data, the method further comprising communicating, with at least one processor, at least a portion of the visible light spectrum data to a display device of at least one operator for real-time monitoring of the at least one scanning drone.

10. The method of claim 1, further comprising automatically generating, with at least one processor, the travel path using at least one of the following: rail track geolocation data, environmental data, train consist data, or any combination thereof.

11. The method of claim 4, further comprising storing, with at least one processor, the primary inspection data and/or the secondary inspection data in a non-transitory, computer-readable storage medium located onboard the at least one scanning drone or the train in a configuration to be later analyzed to detect at least one abnormal train condition.

12. A system for automatic inspection of a train comprising at least one locomotive and at least one railcar, the system comprising:
at least one scanning drone comprising at least one sensor configured to obtain primary inspection data of the train comprising at least one of the following: infrared data, visible light spectrum data, temperature data, sample gas data, sound data, ultrasound data, x-ray data, LIDAR data, radar data, or any combination thereof;
at least one server computer including at least one processor, the at least one server computer programmed and/or configured to:
activate the at least one scanning drone;
communicate at least one set of scanning drone operating instructions configured to cause the at least one scanning drone to obtain the primary inspection data along a travel path associated with the train; and
receive the primary inspection data from the at least one sensor.

13. The system of claim 12, wherein the at least one scanning drone is configured to, when activated, deploy from a storage compartment positioned on or in the at least one locomotive or the at least one railcar, and wherein the at least one scanning drone is configured to return to the storage compartment after executing the at least one set of scanning drone operating instructions.

14. The system of claim 12, further comprising at least one micro drone comprising at least one sensor configured to obtain secondary inspection data of the train comprising at least one of the following: infrared data, visible light spectrum data, temperature data, sample gas data, sound data, ultrasound data, x-ray data, LIDAR data, radar data, or any combination thereof; wherein the at least one server computer is further programmed and/or configured to:
activate the at least one micro drone; and
communicate at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

15. The system of claim 14, wherein the at least one server computer is further programmed and/or configured to:
analyze the primary inspection data and/or the secondary inspection data to detect at least one abnormal train condition; and
communicate at least one notification to at least one operator comprising a warning of the at least one abnormal train condition.

16. The system of claim 14, wherein the at least one server computer is further programmed and/or configured to store the primary inspection data and/or the secondary inspection data in a non-transitory, computer-readable storage medium located onboard the at least one scanning drone or the train in a configuration to be later analyzed to detect at least one abnormal train condition.

17. A computer program product for automatic inspection of a train comprising at least one locomotive and at least one railcar, the computer program product comprising at least one non-transitory computer-readable medium including program instructions that, when executed by at least one processor, cause the at least one processor to:
activate at least one scanning drone comprising at least one sensor configured to obtain primary inspection data of the train comprising at least one of the following: infrared data, visible light spectrum data, temperature data, sample gas data, sound data, ultrasound data, x-ray data, LIDAR data, radar data, or any combination thereof;
communicate at least one set of scanning drone operating instructions configured to cause the at least one scanning drone to obtain the primary inspection data along a travel path associated with the train; and
receive the primary inspection data from the at least one sensor.

18. The computer program product of claim 17, wherein the program instructions further cause the at least one processor to:
activate at least one micro drone comprising at least one sensor configured to obtain secondary inspection data of the train comprising at least one of the following: infrared data, visible light spectrum data, temperature data, sample gas data, sound data, ultrasound data, x-ray data, LIDAR data, radar data, or any combination thereof; and
communicate at least one set of micro drone operating instructions configured to cause the at least one micro drone to: (i) deploy from the at least one scanning drone, (ii) inspect the train on a different travel path from the at least one scanning drone, and (iii) generate the secondary inspection data from detected conditions associated with the at least one railcar.

19. The computer program product of claim 18, wherein the program instructions further cause the at least one processor to:
analyze the primary inspection data and/or the secondary inspection data to detect at least one abnormal train condition; and
communicate at least one notification to at least one operator comprising a warning of the at least one abnormal train condition.

20. The computer program product of claim 18, wherein the program instructions further cause the at least one processor to store the primary inspection data and/or the secondary inspection data in a non-transitory, computer-readable storage medium located onboard the at least one scanning drone or the train in a configuration to be later analyzed to detect at least one abnormal train condition.
